(19) United States
(12) Patent Application Publication
(10) Pub. No.: US 2021/0146300 A1
(43) Pub. Date: May 20, 2021

(54) SYSTEM FOR CARBON SEQUESTRATION, STABILIZATION OF ACTIVE ALKALINE SOLID WASTE, AND A PHENOMENOLOGICAL APPROACH TO CALCULATE CARBONATION EFFECTIVENESS

(71) Applicant: ZAYED UNIVERSITY, Abu Dhabi (AE)

(72) Inventors: Abdel-Mohsen Onsy MOHAMED, Abu Dhabi (AE); Maisa Mabrouk EL-GAMAL, Abu Dhabi (AE); Suhaib HAMEEDI, Abu Dhabi (AE)

(21) Appl. No.: 16/684,310

(22) Filed: Nov. 14, 2019

(51) Int. Cl. B01D 53/34; B01D 53/83; B01D 53/62; B09B 3/00

(52) U.S. Cl. CPC B01D 53/346; B01D 53/83; B01D 53/62; B09B 3/00; B01D 2257/504; B01D 2251/402; B01D 2251/306; B01D 2251/404; B01D 2251/304

(57) ABSTRACT

An automated and controlled system, method and devices perform carbon capture and sequestration, stabilization of alkaline solid wastes, and a phenomenological method for automatically conducting carbonation reaction using the integrated system under specific reaction parameters.

### RELATED APPLICATION

The present application is related to U.S. Pat. No. 8,721,785, granted on May 13, 2014, the entirety of which is hereby incorporated by reference herein.

### BACKGROUND

Carbon capture and storage (CCS) is the capture and diversion of CO₂ and subsequently storing CO₂ safely instead of releasing it into the atmosphere. The application of CO₂ capture and subsequent geological storage is a promising option to significantly reduce Greenhouse Gas emissions. Mineral carbonation involves the capture of carbon dioxide in a mineral form by its reaction with alkaline materials, composed of calcium and magnesium-rich oxides and silicates, leading to the formation of solid carbonate products.

Carbonation of alkaline minerals has been achieved by two approaches; direct gas solid and gas solid-liquid carbonation which are the simplest approaches, where Ca/Mg rich solids are carbonated in a single process step. The solid residues are reacted by direct interaction with CO₂-containing gas. Indirect carbonation, usually through aqueous carbonation, consists of first extracting from the feedstock the reactive Mg/Ca oxide or hydroxide in one step and then, in a subsequent step, reacting the leached cations with CO₂ to form the desired carbonate.

### BRIEF DESCRIPTION OF THE DRAWINGS

FIG. 1 is a diagram of an integrated system for carbon capture and sequestration, and stabilization of alkaline metal wastes, in accordance with some embodiments.

FIG. 2 is a diagram of a reaction chamber, in accordance with some embodiments.

FIG. 3 is a diagram of a gas distributor plate, in accordance with some embodiments.

FIG. 4 is a diagram of a cyclone separator, in accordance with some embodiments.

FIG. 5 is a diagram of a dust collector, in accordance with some embodiments.

FIG. 6 is a diagram of a gas analyzer, in accordance with some embodiments.

FIG. 7 is an external view of a control panel, in accordance with some embodiments.

FIG. 8 is an internal view of a control panel, in accordance with some embodiments.

FIG. 9 is a diagram of an integrated system with sustainable reuse of CO₂ discharge, in accordance with some embodiments.

FIG. 10 is a diagram of a method to pretreat solid waste before carbonation reaction, in accordance with some embodiments.

FIG. 11 is a graph for a function of differential pressure versus flow rate according to an embodiment for determination of the minimum fluidization velocity, in accordance with some embodiments.

FIG. 12 is a graph for a function of consumed carbon dioxide concentration versus time according to an embodiment for determination of optimum reaction time, in accordance with some embodiments.

FIG. 13 is graphs of carbon dioxide concentration versus time according to an embodiment for determination of total amount of carbon dioxide consumed, in accordance with some embodiments.

FIG. 14 is a graph of consumed carbon dioxide concentration as a function time corresponding to different alkaline metal wastes, in accordance with some embodiments.

FIG. 15 is a graph of consumed carbon dioxide concentration as a function time corresponding to different reaction pressures, in accordance with some embodiments.

FIG. 16 is a graph of consumed carbon dioxide concentration as a function time corresponding to different reaction temperature, in accordance with some embodiments.

FIG. 17 is images of formed carbonates in three stabilized alkaline metal wastes, in accordance with some embodiments; (a) fresh and (b) formed carbonates in the stabilized LF slag, fresh (c) and (d) formed carbonates in the stabilized CKD, fresh (e) and (f) formed carbonates in the stabilized CLW

FIG. 18 is a high-level block diagram of a processor-based system usable in conjunction with one or more embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, etc., are contemplated. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The present disclosure involves an integrated and fully controlled fluidized bed reactor for sequestration of carbon dioxide by mineral carbonation, and in one or more embodiments introduces innovative steps to the current traditional reactors to (a) fit the recent environmental applications, (b) optimize the required reaction time, (c) eliminate the need for additional thermal and mineralogical experiments required to determine carbon sequestration efficiency such as thermogravimetric analysis, and (d) ensure a sustainable use of CO₂ during the application process.

The present disclosure also involves a mineral carbonation method and stabilization of industrial alkaline solid wastes by modifying traditionally used reactors. In one or more embodiments, one or more embodiments according to the present disclosure introduces the following added modifications and advantages:

One or more embodiments according to the present disclosure involve a new design of gas distributor plate unit with different geometry distribution of holes that gives more than one scenario of gas flowing to the reactor; hence enhancing the reaction process.

One or more embodiments according to the present disclosure involve applying an automated system, SCADA, which provides an easier controlling and monitoring of affecting parameters such gas flow, temperature and pressure during the reaction and stabilization processes. The control panel, which has a SCADA system inside, ensures environment, health and safety aspects during operation via alarm system in case of emergency for any increase in temperature and pressure above set-points. It has also an air filter and cooling fan to keep electrical controlling components inside the control panel under the allowable operating temperature.

One or more embodiments according to the present disclosure involve providing a cyclone and dust collector to prevent fine solid particles from accompanying the gas before entering the gas analyzer.

One or more embodiments according to the present disclosure involve the connection of a gas analyzer device to the gas outlet stream where it reads the concentration of that stream. Hence, determination of optimum time needed to stop the reaction process and minimize energy use during both carbon sequestration and alkaline solid waste stabilization processes.

One or more embodiments according to the present disclosure involve sustainable use of operated CO₂ gas through recycling/by-pass stream.

One or more embodiments according to the present disclosure introduce a phenomenological technique to identify optimum carbonation time and carbonation efficiency using data monitored by the gas analyzer as a function of time, experimental data, and theoretical equation without the need for additional thermo-mineralogical sets of experiments such as thermogravimetric analysis (TGA).

In one or more embodiments of the present disclosure, the method of carbon dioxide fixation in alkaline solid waste materials is accelerated. In this method, alkaline substances (CaO, MgO, K₂O, Na₂O, or the like) existing in the solid wastes are reacted with carbon dioxide in the integrated system to produce carbonates (CaCO₃, MgCO₃, Na₂CO₃, K₂CO₃, or the like) to fix the carbon dioxide emitted from natural and man-made sources.

One or more embodiments of the present disclosure provide an apparatus for carbon capture and sequestration, stabilization of alkaline solid wastes, and a phenomenological approach to identify optimum carbonation time and carbonation efficiency. The use of the new integrated, automated and controlled system shown in one or more embodiments of the present disclosure is the most promising way to reduce both the capital and operating costs for the mineral carbonation process. Based on researches done so far, traditional mineral carbonation methods show relatively high cost, which limits their application, because they include the cost of mining, pre-treatment, operational technologies of CO₂ sequestration, and others that consume more effort, time and energy. The integrated, automated and controlled system according to one or more embodiments of the present disclosure offers an ideal route to the significant inexpensive technology that could be applied for CO₂ sequestration and waste stabilization, where: (a) no need for grinding the waste stream because it is already in its fine particle sizes which are convenient for the CO₂ sequestration, (b) no thermal energy consumption through the application of direct gas-solid carbonation in this innovative system since reaction is taking place at room temperature, (c) no external mechanical pressure source is required since the fluidization using the pressurized CO₂ provides a well-mixed waste with maximum available exposed particles surface areas for reaction with CO₂. In addition, as shown in one or more embodiments of the present disclosure, the reactor itself is fabricated with minimum cost when it is compared with its efficiency and added advantages due to the inclusion of multi-components such as: (a) newly designed gas distributor plate unit, (b) fully automated controlling and monitoring system, SCADA, which provides easier controlling and monitoring of affecting parameters, (c) cyclone and dust collector to prevent air pollution, and (d) connection of gas analyzer device to the gas outlet stream for accurate carbonation monitoring and optimum identification of carbonation time.

One or more embodiments according to the present disclosure involve systems, devices and methods with the ability to better control gas flow and distribution within the reactor due to optimal design of gas flow holes distribution geometry of the gas distributor unit; hence, maximum interaction between gas and alkaline solid waste particles.

One or more embodiments according to the present disclosure involve systems, devices and methods with the ability to control gas pressure inside the reactor while running experiments.

One or more embodiments according to the present disclosure involve systems, devices and methods with the ability to control the entering gas flow rate to the reactor with a wide range up to 50 l/min with an accuracy of 0.1.

One or more embodiments according to the present disclosure involve systems, devices and methods with the ability to control and apply uniformly distributed heat to the reactor quickly by an electrical heating source in a double jacket around the full height of the reactor.

One or more embodiments according to the present disclosure involve systems, devices and methods with the ability to automatically monitor temperature along the reactor from 3 different positions along the reactor height.

One or more embodiments according to the present disclosure involve systems, devices and methods with the ability to provide high level of gas purity before entering the reactor, (through 7 μm filter, and after leaving the reactor as there is direct interaction between gas and solid, through cyclone dust collector and storage container, and another 7 μm filter at the outlet stream.

One or more embodiments according to the present disclosure involve systems, devices and methods with the ability to identify the optimum reaction time, which is required for direct gas-solid interaction (carbonation), by monitoring the outlet gas stream (unreacted CO₂) using the gas analyzer.

One or more embodiments according to the present disclosure involve systems, devices and methods with the ability to calculate carbonation efficiency using data from the identification of the optimum reaction time above and theoretical equation without the need to conduct thermo-mineralogical experiments such as thermogravimetric analysis (TGA).

One or more embodiments according to the present disclosure involve systems, devices and methods with the ability to identify the exact time to terminate the experiment based on information provided in the identification of the optimum reaction time above; hence, minimizing the operating cost and energy use.

One or more embodiments according to the present disclosure involve systems, devices and methods with the ability to eliminate the needs for additional thermo-mineralogical testing to quantify the maximum carbonation and carbonation efficiency.

One or more embodiments according to the present disclosure involve systems, devices and methods with the ability to automatically monitor temperature, pressure, flow rate and gas (CO₂) concentration by automatic data acquisition system and computer software; hence enhancing data analysis capabilities.

One or more embodiments according to the present disclosure involve systems, devices and methods with the ability to environmentally sustain the use of CO₂ gas stream through adsorption and by-pass units.

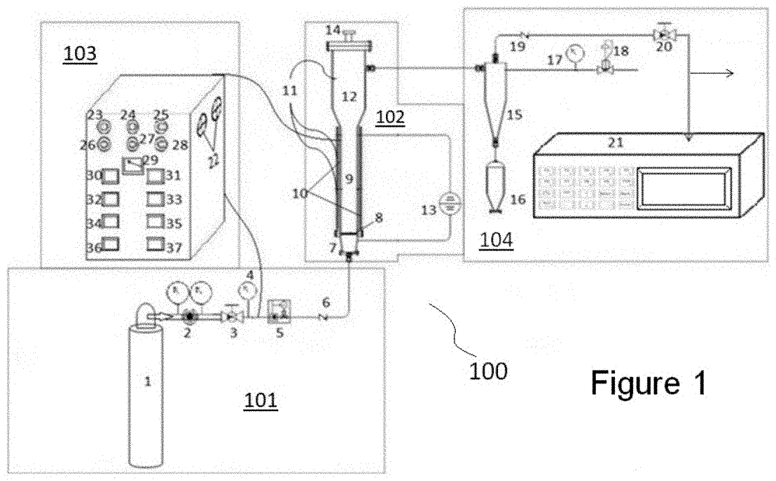

FIG. 1 is a diagram of an integrated system 100 for carbon capture and sequestration, and stabilization of alkaline solid wastes according to one or more embodiments. The integrated system includes a gas feed source 101, a reaction chamber 102, a control panel 103 and a reaction analyzer module 104. In some embodiments, the integrated system 100 is additionally connected to a computer (not shown) having software for a centralized supervisory system such as a supervisory control and data acquisition (SCADA) system.

In some embodiments, the gas feed source 101 includes 6 components and is used to provide well-organized properties of a reaction gas feed to the reaction chamber 102. In some embodiments, the gas feed source is responsible to ensure that the gas feed is at desired pressure, flow rate and free from impurities. As shown by the embodiment of FIG. 1, the gas feed source 101 includes a gas cylinder 1. The gas cylinder 1 is the source of gas fed to the reaction chamber 102. In some embodiments, the gas cylinder 1 has a 40-liter cylinder size and 6 m³ gas filled under average pressure of 150 bar and a shelf life of 3 years. In some embodiments, the gas cylinder 1 is any gas containing, or gas generator providing, a reaction gas, the embodiments shown in the present disclosure are not intended to be limiting. The gas cylinder 1 includes a reaction gas having a predetermined concentration of CO₂. For example, in some embodiments, the gas used may have 10% (volume by volume) CO₂ balanced with air. As shown by the embodiment of FIG. 1, the gas feed source 101 additionally includes a gas regulator 2 attached to the gas cylinder 1. In some embodiments, the gas regulator 2 is any type of regulator that handles an internal gas pressure of the gas cylinder 1. The gas regulator 2 includes two pressure gauges, one to read the pressure inside the gas cylinder 1 while the other reads the pressure of the gas that leaves the gas cylinder 1 after adjusting its value by a wheel regulator. In some embodiments, the first pressure gauge has maximum value of 420 bar and the second one has 16 bars. The gas feed source 101 additionally includes a manual valve 3 connected to the gas cylinder 1. In some embodiments, the manual valve 3 is a ball-type valve used to control the amount and flow rate of the gas needed to pass from the cylinder before entering the system. The gas feed source 101 may additionally include a pressure gauge 4 connected to the manual valve 3. The pressure valve 3 measures the pressure value of allowed entering gas. In some embodiments, the maximum operational value of the pressure valve 3 is 10 bars. A mass control valve 5 is also included by the gas feed source 101 connecting the gas cylinder 1 to the reaction chamber 102. The mass control valve 5 manipulates the amount and flow rate of the reaction gas through electrical signals. In some embodiments, the mass control valve 5 is controlled by the control panel 103 and/or a computer having a SCADA system, which is discussed in subsequent paragraphs of the present disclosure. In some embodiments, the mass control valve 5 has a set point (value) which is selected from a range (0-50 liter/min.) with accuracy of 0.1 level. A filter 6 is installed between the connection of the mass control valve 5 and the reaction chamber 102. The filter 6 is used to avoid any fine particle that may contaminate the gas feed. In some embodiments, the filter 6 is 7 μm in size and is attached inline of a pipe.

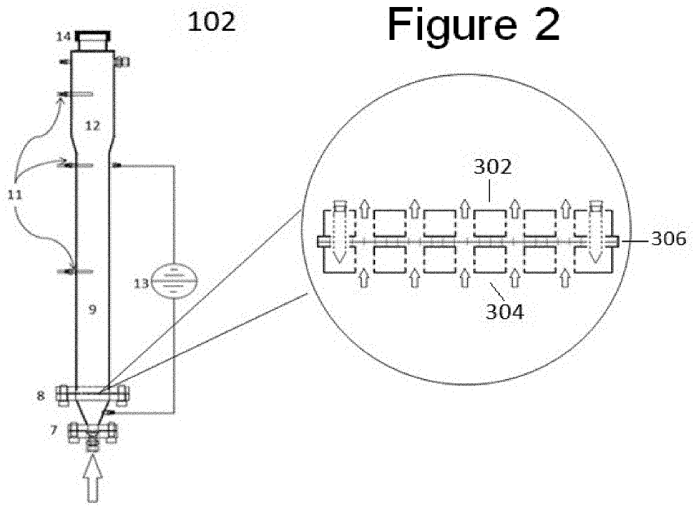

As shown in the embodiments in FIG. 1 and FIG. 2, the reaction chamber 102 includes 8 components and is considered the core part of the system. The reaction chamber 102, or more precisely the reactor column 9, is where carbonation reaction, CO₂ sequestration, and stabilization of alkaline solid wastes take place. The reaction parameters such as temperature and pressure are monitored and controlled by the control panel 103 and/or automatically by the inclusion of a computer with SCADA system which is discussed in subsequent paragraphs of the present disclosure.

The reaction chamber 102, as shown in the embodiments in FIG. 1 and FIG. 2, includes a reactor column 9 in which the carbonation reaction, CO₂ sequestration, and stabilization of alkaline solid wastes are taken place. In some embodiments, the reactor column 9 is made of stainless steel 316 with enough thickness to handle operational pressure up to 10 bars. In some embodiments, typical transparent reactor with ambient temperature and pressure operational conditions (i.e.: up to 40° C. and 1 atm) was manufactured and attached to the reactor frame to give visible observations of direct gas-solid interaction before running experiments in the main stainless-steel column. The reactor column 9 includes a gas entrance 7 where it allows the gas to come from the bottom through an overturned conical shape. A gas distributor plate 8 is placed above the gas entrance 7 on the reactor column 9.

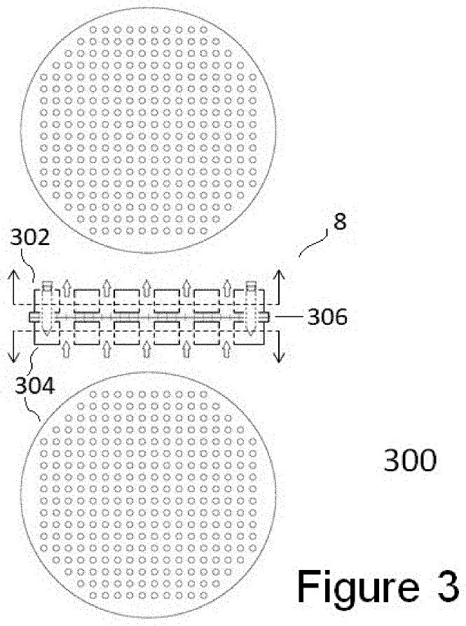

As shown in the embodiments of FIG. 3, A gas distributor plate assembly 300 includes the gas distributor plate 8 has two discs 302 and 304 with symmetrical holes geometry and 30 μm mesh 306 in between. The gas distributor plate 8 provides uniform distribution of the gas feed along the reactor column 9, while the mesh prevents solid particles from passing downward out from the reactor column 9, provided that the particle size of the loaded solid is larger than the mesh size used. In some embodiments, as shown in FIG. 3, the gas distributor plate 8 has holes distribution geometry on the plate: polygon and concentric, respectively. The reaction chamber 102 also includes a lid 14 covering the top opening of the reactor column 9 which opening is to receive any solid alkaline metal waste for the carbonation reaction. In some embodiments, the lid 14 is made from stainless steel. In some embodiments, as shown in FIG. 1 and FIG. 2, the reactor column 9 additionally includes an expansion part 12. The expansion part 12 is designed with a diameter slightly greater than that of the reactor column 9 to give wider space for the gas above the reactor column 9 and allowing taking in of higher pressure. The expansion part 12 also minimizes the amount of fine solid particles that may travel with the gas from the top.

In some embodiments, the reaction chamber 102 also includes electrical heating element 10 installed around the outside wall of the reactor column 9 to provide an insulated rapid heating source to the reactor column. In some embodiments, the electrical heating element 10 has a double jacket shape. In some embodiments, the electrical heating element 10 has a maximum allowed temperature 200° C. after which an alarm starts buzzing. Nevertheless, the electrical heating element 10 can provide as much heat as electrical current can pass through. The limit of 200° C. was set in the design stage and can be adjusted as desired. In some embodiments, the electrical heating element 10 provides a maximum allowed temperature greater than 200° C.

In some embodiments, the reaction chamber 102 also includes thermocouple thermometers 11. As shown in the embodiments of FIG. 1 and FIG. 2, the thermocouple thermometers 11 measure temperatures at 3 positions along the reactor, one at the expansion part 12, one at the top opening of the reactor column 9, and one at the middle part of the reactor column 9. The positions of the thermometers 11 are shown in FIG. 1 and FIG. 2; but one example of the arrangement of thermometers 11 is along the reactor column 9. In fact, the position of the thermometer can be arbitrarily varied by the user of the integrated system to correspond to specific reaction requirements, and the positions shown in the present disclosure are not intended to be limiting.

In some embodiments, the reaction column additionally includes differential pressure transmitter 13 to measure the pressure difference across the top and bottom of the reactor column 9. When solid particles are loaded inside the reactor column 9 they cause some resistance against the gas flow and so slightly reduce the pressure at the top. In some embodiments, the differential pressure transmitter 13 can read that small difference in (mm-H₂O) unit. Such measurements can be employed to experimentally determine the minimum suspension velocity from the recorded change in pressure versus flow rate.

The reaction analyzer module 104, as shown in the embodiments of FIG. 1, includes 7 components to separate the outlet gas from any solid particles and analyze the concentration of CO₂ in the outlet gas with, in some embodiments, a gas analyzer 21. In some embodiments, the readings of the reaction analyzer module 104 can be connected to a computer with a SCADA system and/or data acquisition and analyzing software such as LabVIEW to automatically analyze and determine the result of the reaction occurred in the reactor column 9.

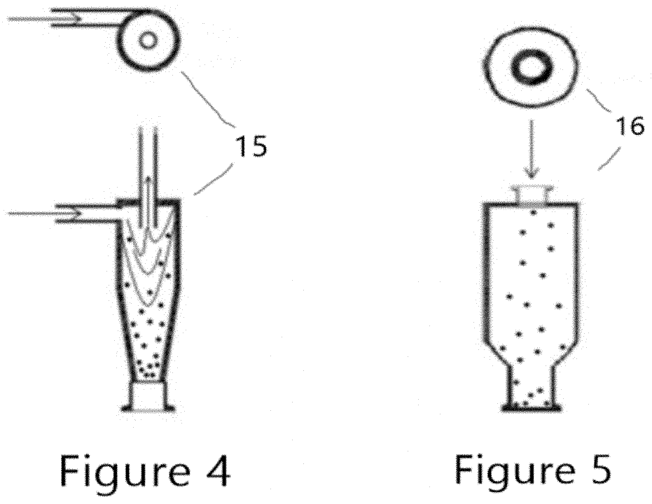

As shown in the embodiment of FIG. 1, the reaction analyzer module 104 includes a cyclone separator 15, as shown in FIG. 4, connected with the top opening of the reactor column 9 or through the expansion part 12 to separate the outlet gas with any fine solid particles that may undesirably accompany the gas after leaving the reactor column 9 by gravity settling concept within such conical shape, as shown in the embodiment of FIG. 4. Consequently, gas continues its way upward to the exit. In some embodiments, a solid particle collector 16, as shown in FIG. 5, is connected with the cyclone separator 15 to gather collected fine solid particles passing through the cyclone collector. In some embodiment, the solid particle collector 16 is designed with specific shape that gives good way to settle solid particles, as shown in FIG. 5. A pressure gauge 17 is connected with the cyclone separator 15 to measure the pressure of the outlet gas existing the reactor column and entering the cyclone separator 15. In some embodiments, a safety valve 18 is connected to the pressure gauge 17 to form an emergency outlet to vent the outlet gas into atmosphere in case the reading of the pressure value exceeds the allowed designed value. In some embodiments, the designed maximum value is 10 bar.

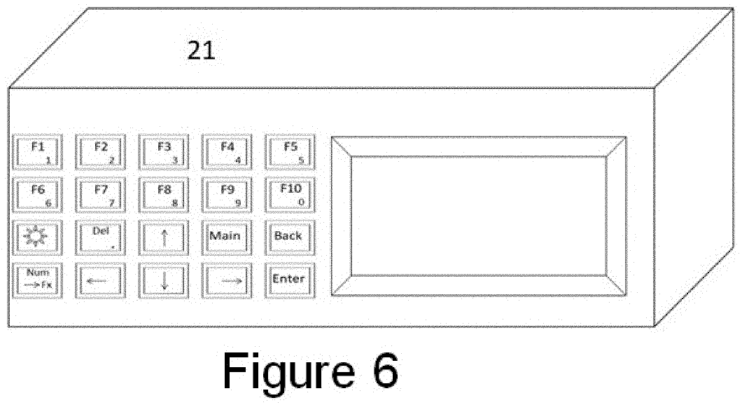

The reaction analyzer module 104 also includes a gas analyzer 21, as shown in FIG. 6, connected with the cyclone separator to receive the purified outlet gas. The gas analyzer 21 measures the concentration of CO₂ gas in the leaving stream in CO₂ volume per total gas volume percentage unit (v/v %). FIG. 6 shows a graphical sketch of the gas analyzer 21. The gas analyzer 21 indicates the concentration of unreacted CO₂ that passes through loaded solid particles inside the reactor while running the experiment. Since the reaction gas coming from the gas feed source 101 has a predetermined concentration of CO₂, the amount of CO₂ reacted with the alkaline solid waste can be calculated by using the difference between the constant value of the feed and the outlet measurements. The readings of the gas analyzer 21 can be taken automatically by a computer having software such as LabVIEW program, and/or a SCADA system.

In some embodiments, a filter 19 is attached inline of the exit pipe exiting the cyclone separator 15 connecting to the gas analyzer 21. The filter 19 serves as an additional prevention apparatus to avoid any fine particle that may contaminate the gas stream before going for analyzing by the gas analyzer 21. In some embodiments, the filter has a size of 7 μm.

In some embodiments, another pressure valve 20 is installed between the cyclone separator 15 and the gas analyzer 21. A venting bypass is included on the gas pipe between the pressure valve 20 and the gas analyzer 21 to partially vent the outlet gas into the atmosphere. The pressure valve 20 is used to adjust the desired pressure inside the reactor and it controls the amount and flowrate of the leaving gas, which separate to two streams, one to be vented into the atmosphere, the other to the gas analyzer 21.

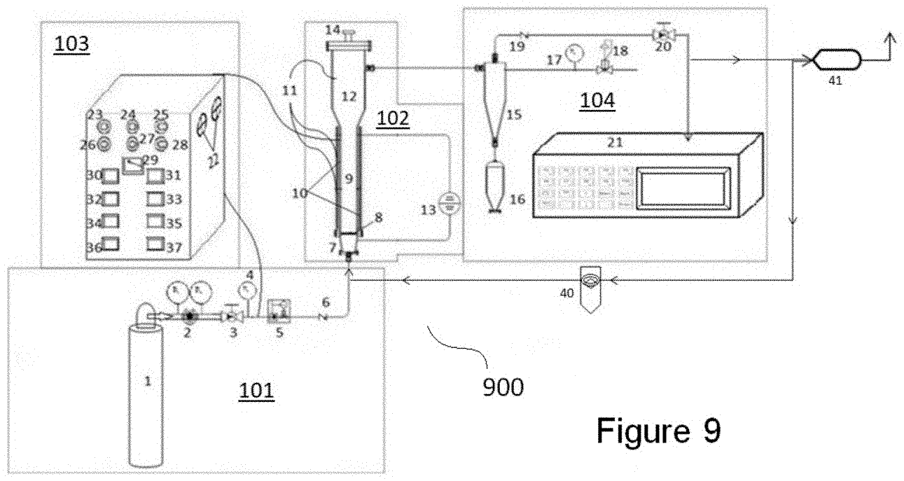

FIG. 9 depicts a reactor system 900, in some embodiments. In some embodiments, the venting bypass on the gas pipe in between the pressure valve 20 and the gas analyzer 21 is further connected to a bypass stream pipeline as shown in the embodiment in FIG. 9. The bypass stream pipe re-injected stream of the outlet gas to the reactor column 9 in the reaction chamber 102. The outlet gas re-injected would be mixed with the main gas feed also entering the reactor column 9. A flow meter 40 is installed on the bypass stream pipe to measure the flow rate of the outlet gas re-injected. In some embodiments, this flow meter 40 is controlled by the computer with a SCADA system. In some embodiments, another gas analyzer can be installed in-line on the bypass stream pipe before entering the reactor chamber 9 to measure the CO₂ concentration of this re-injected outlet gas. In some embodiments, this second gas analyzer is also controlled by the computer with a SCADA system. Another stream that can reuse CO₂ from outlet is through using a chamber 41 that contains pure MgO where carbonation occurs and stable material produced MgCO₃.

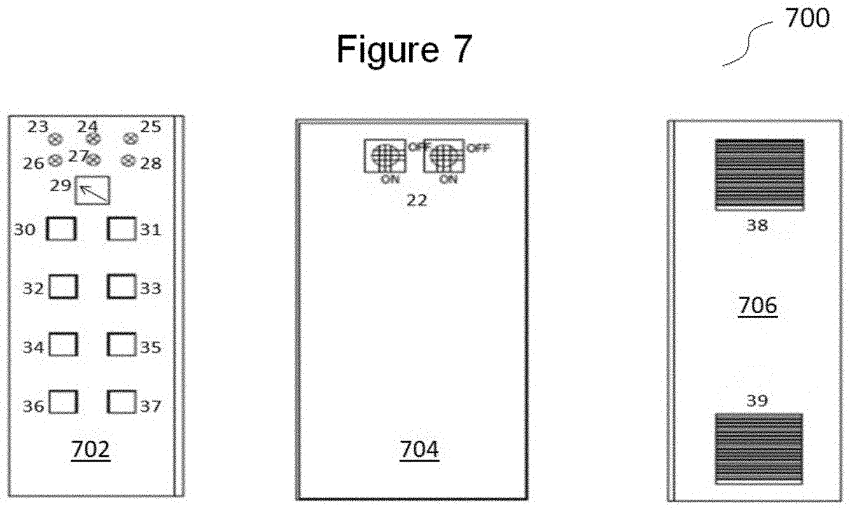

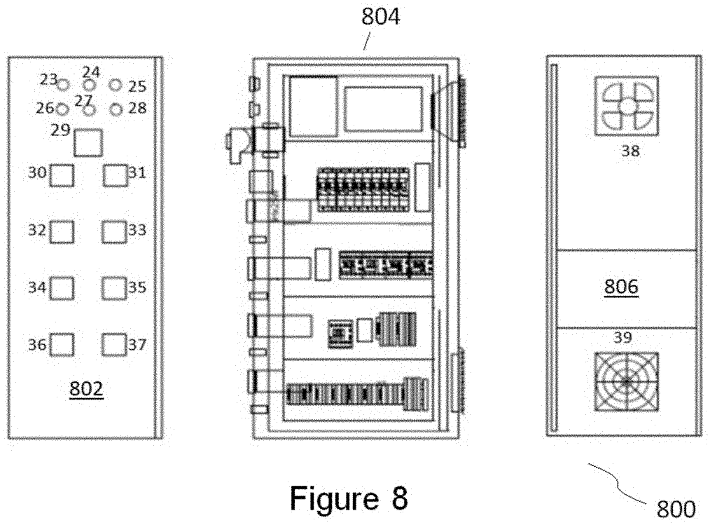

FIG. 7 depicts the external view of a control panel 700, in some embodiments. A front view 702, a door external view 704 and a back view 706 are depicted. FIG. 8 depicts the internal view of a control panel 800. A front view 802, a rearview 804 and an RHS view 806 are depicted. As shown in the embodiments of FIG. 1, FIG. 7 and FIG. 8, the control panel 103 includes at least 18 components. The control panel 103 is considered the brain of the system where it monitors and controls affecting reaction parameters during the reaction process. In some embodiments, the control panel can be operated manually. In some embodiments, the control panel can instead be directed by an attached computer that has compatible software (such as IFIX) and/or a SCADA system to automatically monitor and control the affecting reaction parameters.

The control panel 103 includes power supply switches 22 to control the main power supply. In some embodiments, the power supply switches 22 includes two spin type switches one for the main power supply and the other for whole electrical components (boards) for safety purpose. A light of “Main Power on” 23 indicating that the main power is switched on and supplied through main switch can also be installed. Another light of “Unit Power Supply (UPS) on” 24 indicating that the power is supplied through UPS switch can also be installed. A light of alarm 25 is also included according to some embodiments. The light of alarm 25 will light up in case of any caution occurs during the operation. It's good to know that such cautions can be set by the operator based on conditions required for each experiment. For example: if the temperature of thermal heating element exceeds a set point (can vary based on each experiment conditions), the light of alarm 25 will light up and accompanied with alarm noise. In some embodiments, the control panel 103 also includes: a reset button 26 to reset all set values of all the controllers described in the subsequent paragraphs of the present disclosure into their default values and the current value of all the controller can also be adjusted and saved as new default values; a mute alarm button 27 to mute the alarm sounds accompanying the light of alarm 25; an emergency stop button 28, to terminate all heating and feeding of the reaction gas in an emergency case, an ammeter 29 to measure the value of electrical current flowing inside the electrical heating elements 10 of the reaction chamber 102, a fan 38 for cooling inside the panel, such fan is required to cool down the temperature of the inside the control panel as there are integrated electrical parts such as PLC's chips and boards; and/or air filter 39 to purify the air used for cooling by the fan 38 that comes from the ambient to inside the control panel while suctions.

The control panel 103 also includes a variety of controllers and indicators controlling and displaying reaction parameters for the carbonation reaction inside the reactor column 9 of the reaction chamber 102. In some embodiments, the control panel 103 includes a temperature controller and indicator 30 to adjust and measure the temperature of the electrical heating elements 10 of the reaction chamber 102. Several reactor column temperature indicators 31-33 are also included according to some embodiments. These temperature indicators 31-33 each respectively display the temperature reading of the thermocouple thermometers 11 at their respective position along the reactor column 9. For example, as shown in the embodiment of FIG. 1, the temperature indicator 31 can display temperature at the expansion part 12; the temperature indicator 32 can display temperature at the top opening of the reactor column 9; the temperature indicator 33 can display temperature at the middle part of the reactor column 9. In some embodiments, the temperature controller 30 is controlled by a computer having a SCADA system and the readings of temperature indicators 30-33 is automatically taken by the computer having a SCADA system.

In some embodiments, the control panel 103 also include several pressure indicators 34, 35. As shown in FIG. 1, FIG. 7 and FIG. 8, in some embodiments, a pressure indicator 34 is installed to display the pressure value of the outlet gas from the reactor column 9 as measured by the pressure gauge 17. In some embodiments, a differential pressure indicator 35 is installed to show the differential pressure value across the reactor column 9 measured by the differential pressure transmitter 13. In some embodiments the reading of the differential pressure indicator 35 is in mmH₂O unit. In some embodiments, the readings of the pressure indicator is automatically taken by the computer having a SCADA system.

In some embodiments, the control panel 103 includes a mass flow rate controller and monitor 36 to control the mass control valve 5 through electric signals to select a value of the flow rate of the gas stream from the gas feed source 101. The monitor 36 can also display such selected flow rate. In some embodiments, the flow rate has the unit of liter/min. In some embodiments, the controller 36 can select flow rates from a range of 0-50 liter/min with an accuracy of 0.1 liter/min. In some embodiments, the mass flow rate controller 36 is controlled by a computer having a SCADA system to automatically adjust the flow rate of the gas stream from the gas feed source 101.

The operation conditions of the integrated system 100 involves a variety of parameters which, in some embodiments, includes but not limited to: (a) waste type, quantity and humidity, (b) reaction chamber temperature and pressure, (c) gas flow rate and distribution, and (d) time required to finalize the carbonation. It is important to note that these parameters are not intended to be limiting and some of these parameters can be removed, and additional parameters can be introduced based on the nature of the reaction conducted. Table 1 shows an example of conditions used in some experiment conducted to provide examples of the phenomenological method for conducting carbonation reaction of solid mineral waste particles using the integrated system 100 described in subsequent paragraphs of the present disclosure.

TABLE 1
Operation conditions of the integrated system

| Operational conditions | Explanation |
|---|---|
| Waste description | Type: Solid |
| | Size: From 38 μm to 2 mm |
| | pH > 9 |
| | Chemical composition: It should contain alkali and alkaline |
| | oxides, hydroxides or silicates |
| Waste quantity | It is governed by the physical properties of solid particles provided |
| | that the height of loaded solid particles does not exceed ⅓ of the |
| | total height of the reactor |
| Flow rate | From 0-50 l/min with digital flow meter with accuracy of 0.1. |
| | The flow rate varies based on the type of solid wastes as they have |
| | different physical properties such as percentage of the oxides, |
| | specific gravity, particle size, sphericity, percentage of the voids. |
| Moisture (Humidity) | From 1 to 4% |
| percentage | |
| Inlet CO₂ | It depends on the feed source; pure CO₂ or any percent of air |
| | mixtures |
| Temperature range | From ambient temperature up to 200° C. |
| Pressure range | From 1 to 10 bar |
| Carbonation time/efficiency | It depends on the percentage of the oxides and the chemical |
| | composition of the solid wastes. |
| | Optimum carbonation time can be determined from gas analyzer |
| | measurements. |

The embodiments of the integrated system 100 as disclosed in the present disclosure is used to perform a phenomenological method for conducting carbonation reaction under optimum reaction parameters. Utilization of the new integrated controlled system is the most promising way to reduce both the capital and operating costs for mineral carbonation processes.

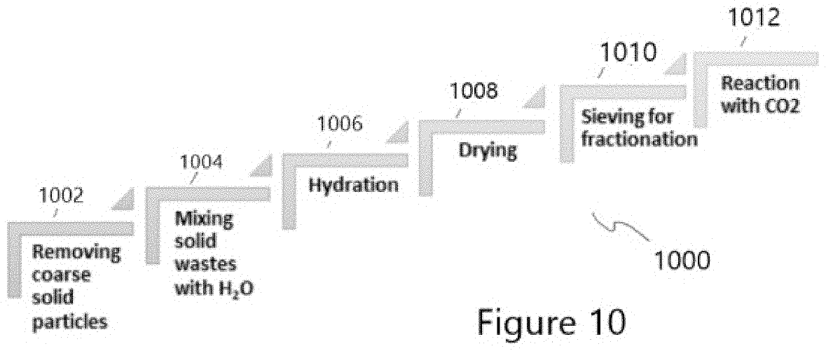

The method for conducting carbonation reaction of solid mineral waste particles using the integrated system 100 includes a step of pre-treating any solid alkaline metal wastes to be used for the reaction. At the start of carbon capture and storage (CCS) planning, it is important to know what types of waste are generated, and what about the alkalinity, particle size, chemical structure, and the mineralogical composition. This information is crucial to the development of the key strategies and components of CCS plan. As disclosed in the present disclosure, the collected solid waste is pretreated before running the carbonation process by removing coarse solid particles from the fine particles during sieving analysis 1002, hydration through mixing with water 1004 and 1006, followed by drying 1008 and fractionation of the solid particles using a certain sieve sizes 1010 and reacting with CO₂ 1012, as described clearly in the previous author's U.S. Pat. No. 8,721,785 B2 the subject matter of which is incorporated herein in its entirety, and indicated in FIG. 10.

Direct gas-solid carbonation reaction of the pretreated solid wastes is carried out in the integrated system 100. The concentration of captured CO₂ by solid wastes is instantaneously measured using a gas analyzer 21. Readings are taken automatically via a computer having professional data acquisition program such as LabVIEW and/or a SCADA system. After the allotted reaction period, the reactor column 9 is opened, and the carbonated solid wastes are discharged for analyses.

The method for conducting carbonation reaction of solid mineral waste particles using the integrated system 100 also includes a step of determining a reaction rate for the carbonation reaction. In the following examples, experiments were run in reactor column 9 where solid particles moved with similar velocity of the entering gas causing particle suspension/fluidization. Fluidization condition is generally occurred when small solid particles are suspended in an upward flowing stream of liquid or gas; hence creating excellent mixing environment. The equation that relates the controlling parameters of that fluidization process is generally expressed by Ergun equation (Fogler 1981; Kunii and Levenspiel 2013) as shown below:

$$\frac{Δ P}{L} = \frac{150 μ {V}_{0}}{{D}_{p}^{2}} \frac{{( 1 - ɛ )}^{2}}{{e}^{3}} + \frac{1.75 {ρ}_{g} {V}_{0}^{2}}{{D}_{p}} \frac{1 - e}{{e}^{3}} \qquad [ 1 ]$$

where: ΔP is the gas pressure difference across bottom and top of the reactor, L is the height of the loaded solid particle inside the reactor, μ is dynamic viscosity of the liquid/gas, V₀ is velocity of liquid/gas, Dₚ is particle size of the solid, ε is void fraction, ρ_{g} is density of liquid/gas.

There are many other developed semi-empirical correlations, which relate physical properties of both solid and fluid (liquid/gas), used to specify the flow rate required to operate the fluidization process.

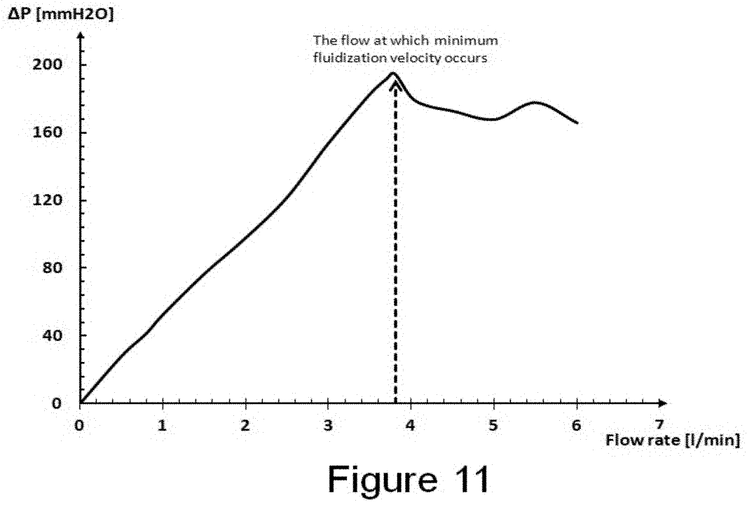

To deal with the mixing between CO₂ gas and solid waste particles (fluidization process), it is necessary to measure the appropriate operational flow rate (minimum fluidization velocity) for solid particles using the designed transparent reactor column 9 (that has the same dimensions as the steel one) by plotting pressure drop change across the loaded solid waste particles versus the flow rate as shown in FIG. 11. The data will show a steady increase in pressure drop with flow rate increase up to a maximum point after which the pressure drop will slightly decrease then fluctuate with flow rate increase. The increase of flowrate is achieved automatically by a computer having a SCADA system controlling the mass control valve 5 to adjust the flow rate of the gas feed. The pressure differential value is also taken automatically by the SCADA system by automatically taking the readings of the differential pressure indicator. The first maximum point on the graph will determine the flow rate at which fluidization will occur. The fluidization flow rate will vary with particle size of the tested solid waste. It is to be noted that the experimentally determined fluidization flow rate may vary from the theoretical one calculated by the Ergun equation or any other derived correlations. However, because of assumptions and difficulties in expressing the controlling parameters in those equations, one would be more inclined to use that experimentally determined fluidized flow rate because it reflects the actual physio-chemical properties of the flow and the reacting materials within the reactor. As discussed in the operational conditions of the integrated system 100 and shown in Table 1, in some embodiments, this system 100 is designed to accommodate variable fluidized flow rates from 0.1 to 50 l/min depending on the particle sizes of the loaded solid waste.

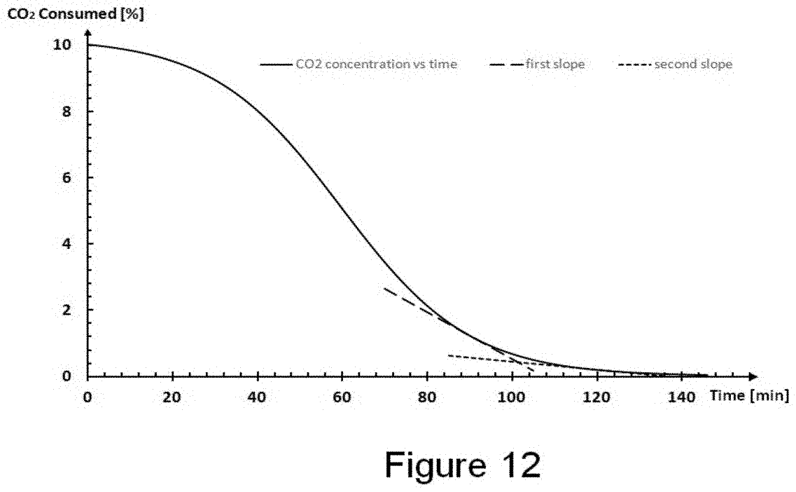

The method for conducting carbonation reaction of solid mineral waste particles using the integrated system 100 also includes a step to determine a carbonation time for the carbonation reaction. Mineral carbonation time is the time taken for fixation of CO₂ by alkali and alkaline-earth oxide. Using the gas analyzer 21, carbonation time can be directly determined, either manually or by the SCADA system. The gas analyzer 21 indicates the concentration of unreacted CO₂ that passes through loaded solid waste particles inside the reactor column 9 while running the carbonation reaction. The carbonation time is calculated experimentally from the curve of CO₂ consumed concentration versus time as shown in FIG. 12 generated either manually or by a SCADA system according to some embodiments. The concentration of output gas stream (unreacted) is automatically measured by a computer, having a SCADA system and/or data generating and analyzing software such LabVIEW program, connected to the gas analyzer 21. The SCADA system and/or the program has an option to specify the period to record the readings on a millisecond scale. To determine the optimum time at which insignificant reaction occurs, i.e. almost all active sites have been reacted with CO₂, the trend curve of consumed CO₂ is required, which is calculated automatically or manually according to some embodiments by subtracting the instantaneous gas analyzer reading from the continuous CO₂ feed. FIG. 12 shows the graphical determination of the time needed for carbonation reaction by generating two slopes: the first one at the point where the plot changes its curvature and the second at the point at which insignificant changes of consumed CO₂ commence. It specifies the optimum time at which the experiment could be terminated. Therefore, operational cost can be minimized, and energy saving can be achieved.

As an example, based on the experimental data shown in FIG. 12, the optimum carbonation time is determined to be at 101 minutes, which is within the range of 70-75% of the total elapsed time of the experiments (140 minutes) where the exit CO₂ concentration is equal to that at the inlet source. It is worth noting that the area under the curve till this optimum point is within the range of 95-98% of the area under the curve of overall time, meaning that at this point 95-98% of total carbonation has been achieved. Therefore, this experimental determination leads to minimizing the operational cost as it conserves the energy sources.

In some embodiments, the reaction parameters can be set manually through the control panel 103. In some embodiments however, the method for conducting carbonation reaction of solid mineral waste particles using the integrated system 100 include a step wherein a computer having a SCADA system automatically controls the mass control valve 5 to adjust the flow rate of the gas feed to be corresponding to the determined optimum reaction time as described in previous paragraphs of the present disclosure. Additionally, in some embodiments, the SCADA system can also control the pressure valve 20 to adjust the pressure of the outlet gas from the reactor column 9 to correspond to a desired pressured. In some embodiments, the desired pressure can also be determined automatically by the SCADA system as described in subsequent paragraphs of the present disclosure. Also, in some embodiments, the SCADA system can also control the electrical heating elements to correspond to a desired reaction temperature. In some embodiments, the desired pressure is also determined automatically by the SCADA system as described in subsequent paragraphs of the present disclosure.

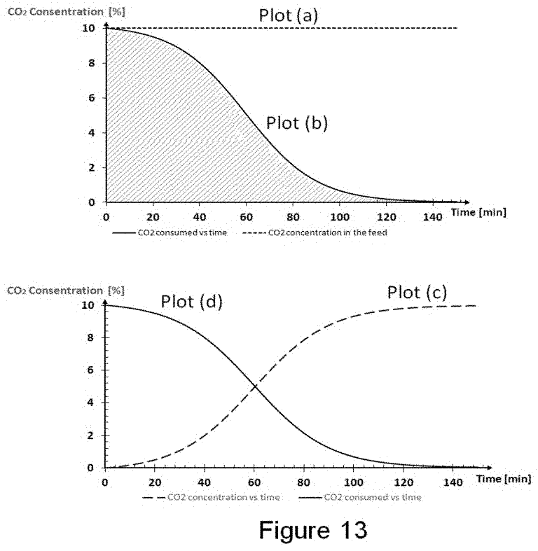

In some embodiments, the method for conducting carbonation reaction of solid mineral waste particles using the integrated system 100 includes a step to determine the total amount of CO₂ captured/consumed. The curve of CO₂ consumed concentration versus time as shown in FIG. 13, generated either manually or by a SCADA system according to some embodiments, is employed to calculate the amount of CO₂ captured/consumed by getting the area under the curve, which is equal numerically the integration of that plot along the optimum time determined. The constant line shown in FIG. 13 (Plot a) represents the continuous constant gas feed during the carbonation experiment. The values shown in FIG. 13 (Plot b) are those calculated as the input CO₂ minus output CO₂ measured by the gas analyzer. Its integration (area under the curve) equals numerically the total amount that has been fed to the solid waste. It represents the total CO₂ consumed by alkaline solid waste during the carbonation process. FIG. 13 (Plot c) monitored CO₂ output by the gas analyzer (component 21, FIG. 9). FIG. 13 (Plot d) calculated as input CO₂ (Plot a) minus monitored CO₂ by the gas analyzer (Plot c).

The physio-chemical properties of solid wastes also have an effect on carbonation time. As the alkaline solid wastes are provided from different industrial factories, the physical and chemical properties are varied. Table 2 shows three of selected wastes used as an example. All alkaline metal wastes can be used in the present disclosure and the information in Table 2 is not intended to be limiting. The cumulative grain size distributions of these solid waste particles were determined by sieving analysis, the cumulative grain size distribution was ranging from 1000 to 38 μm (Table 3). The chemical composition of freshly tested wastes was characterized using ICP-AES, as shown in Table 4.

TABLE 2
Alkaline Solid Wastes, Origins and Types

| Categories | Type of Wastes | Collection Area of Wastes |
|---|---|---|
| Wastes generated in | Cement kiln dust | Cement kiln dust residues were supplied by a cement |
| cement industry | (CKD) | factory in Al Ain, UAE. Samples were taken from open |
| | | storage piles in the weathering area. |
| Wastes generated in steel | Ladle Furnace (LF) | Steel-making residues were collected from Emirates |
| industry | slag | Steel in Abu Dhabi, UAE, from an open storage |
| | | weathering yard. |
| Acetylene by-product | Carbide lime waste | carbide lime wastes were obtained from Sharjah |
| | (CLW) | oxygen company, UAE. |

TABLE 3
Sieve Analysis of Fresh Tested Waste Materials

| Average | Average Mass | Average Mass | Average Mass |
|---|---|---|---|
| Particle | Fraction of | Fraction of | Fraction of |
| Size | CKD Waste | CL Waste | LF Waste |
| (μm) | (%) | (%) | (%) |
| x > 600 | 0 | 21.8 | 7.1 |
| 300 < x < 600 | 0 | 9.3 | 12.6 |
| 150 < x < 300 | 0 | 27.2 | 20.7 |
| 75 < x < 150 | 8.7 | 29.1 | 32.6 |
| 38 < x < 75 | 56.3 | 11.6 | 21.2 |
| x < 38 | 35.0 | 1.0 | 5.8 |
| Total | 100.0 | 100.0 | 100.0 |

TABLE 4
Chemical Analysis of Fresh Solid Wastes Using ICP

| Type of | SiO₂ | | FeO | CaO | MgO | |
|---|---|---|---|---|---|---|
| Waste | (%) | Al₂O₃(%) | (%) | (%) | (%) | others |
| LF Slag | 30.41 | 10.12 | 2.34 | 42.08 | 4.33 | 10.72 |
| CKD | 12.63 | 2.26 | 2.08 | 46.41 | 0.89 | 35.73 |
| CLW | 2.50 | 1.30 | 0.06 | 68.30 | 0.17 | 27.67 |

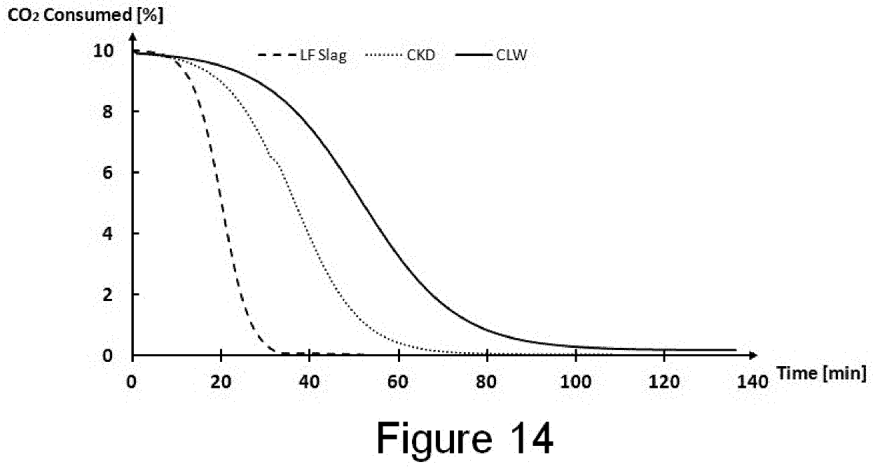

FIG. 14 shows the instantaneous CO₂ concentration while running a carbonation by the integrated system 100 for the three selected wastes. The plot gives the total amount of CO₂ consumed during carbonation process. It is clearly noted that, the saturation time is directly proportional with the amount of alkaline oxides contained in the waste materials. Moreover, the nature of solid wastes, particle size diameter and specific surface area affect the carbonation time. Table 5 shows the experimentally determined phenomenological parameters for the three tested wastes.

Since fluidization occurs whenever a collection of particles is subjected to upward fluid flow at enough flow rate where the gravity and inter-particle forces are in counterbalance with the fluid drag force, as described in Horio, 2013, it was reported in the literatures that minimum fluidization velocity is linearly proportional with particle size. Table 5 indicates the flow rate with CKD solid particles is significantly lower than that accompanied with CLW and LF slag because it contains most of the particle size in the range of 75 to less than 38 μm. Table 5 also shows that the carbonation time and CO₂ captured are directly proportional to the presence of the alkaline oxide contents in the solid waste. This is because alkaline metals are the preferable active centers for reaction with CO₂ than other oxides. The carbonation time and CO₂ captured in case of CLW confirm this explanation.

TABLE 5
Experimentally Determined Phenomenological Parameters
for Samples Tested at Constant Temperature of 22° C.,
and Constant Pressure of 1 atm

| | Fluidization | Carbonation | CO₂ |
|---|---|---|---|
| | Flow Rate | Time | Captured |
| Type of Wastes | (liter/minute) | (minutes) | (g) |
| Ladle Furnace (LF) slag | 4.3 | 33 | 15.9 |
| Cement kiln dust (CKD) | 3.7 | 58 | 33.7 |
| Carbide lime waste (CLW) | 3.9 | 88 | 37.4 |

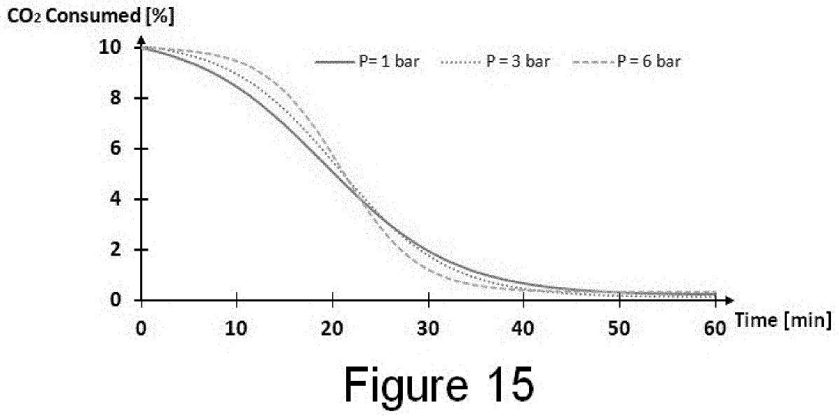

In some embodiments, the method for conducting carbonation reaction of solid mineral waste particles using the integrated system 100 includes a step determining a reaction pressure for the carbonation reaction. In some embodiments, carbonation of solid waste particles under different levels of pressure was established using the integrated system. In some embodiments, the required pressure level can be adjusted either manually by the gas regulator 2 or automatically by the SCADA system which controls the pressure 20. In some embodiment the SCADA system automatically record the pressure value reading of the pressure indicator 34. In some embodiments, the pressure of feed gas is larger than the required operated one by at least 1 bar. FIG. 15 shows three operational pressure levels while mineral carbonation represented by the trend of CO₂ captured. It is indicating that the carbonation time and CO₂ captured are slightly affected by the change in the CO₂ applied pressure in this carbonation process. Table 6 shows the experimentally determined phenomenological parameters for Ladle Furnace (LF) slag, tested at a constant temperature of 22° C. with pressure variations, as an example. It is evidently shown that the CO₂ captured is directly proportional to the increase in CO₂ applied pressure. Whereas, the carbonation time is inversely proportional to the change of the CO₂ applied pressure.

TABLE 6
Experimentally Determined Phenomenological
Parameters for Ladle Furnace (LF) slag,
tested at Constant Temperature of 22° C.

| Pressure | Carbonation | CO₂ |
|---|---|---|
| level | Time | Captured |
| (bars) | (minutes) | (g) |
| 1 | 36 | 16.4 |
| 3 | 34 | 17.2 |
| 6 | 31 | 17.8 |

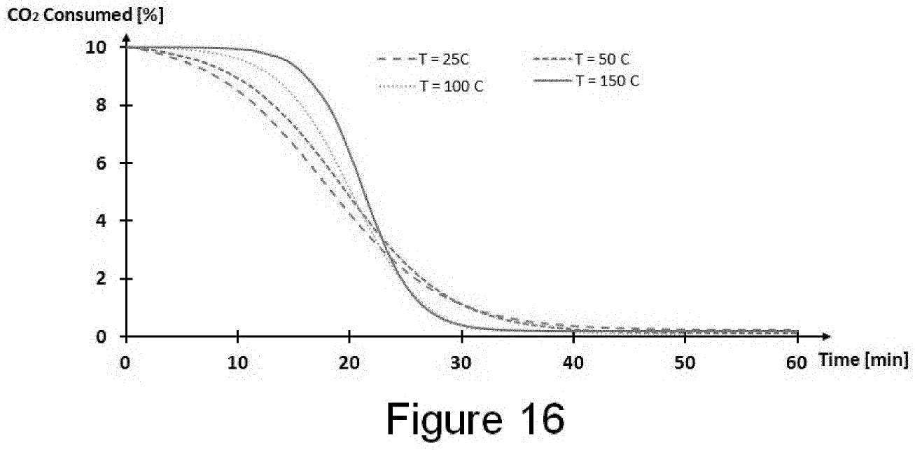

In some embodiments, the method for conducting carbonation reaction of solid mineral waste particles using the integrated system 100 includes a step determining a reaction temperature for the carbonation reaction. For example, carbonation of solid waste particles for Ladle Furnace (LF) slag under different temperature levels: 25, 50, 100, and 150° C. is carried out and the result is shown in FIG. 16 and Table 7. In some embodiments, the required operated temperature level can be adjusted automatically by a computer having the SCADA system controlling the electrical heating element 10. In some embodiment, the required operated temperature level can be adjusted manually by the temperature controller 30. FIG. 16 shows four operational temperature levels while mineral carbonation represented by the trend of CO₂ captured. Table 7 displays the experimentally determined phenomenological parameters for Ladle Furnace (LF) slag, tested at a constant pressure of 1 atm pressure with temperature variations. It is indicating that the increase in the carbonation temperature enhances the CO₂ captured due to the increase of reaction rate constant, pore diffusion coefficient and product layer diffusion coefficient. Moreover, the increase in temperature increases the exposed fresh surfaces for carbonation reaction and consequently increases the CO₂ captured. Correspondingly, Table 7 shows a decrease in carbonation time with temperature due to CO₂ reaction acceleration.

TABLE 7
Experimentally Determined Phenomenological
Parameters for Ladle Furnace (LF) slag, tested
at Constant pressure of 1 atmospheric pressure

| | Carbonation | CO₂ |
|---|---|---|
| Temperature | Time | Captured |
| (° C.) | (minutes) | (g) |
| 25 | 35 | 15.6 |
| 50 | 33 | 16.2 |
| 100 | 30 | 16.7 |
| 150 | 27 | 17.3 |

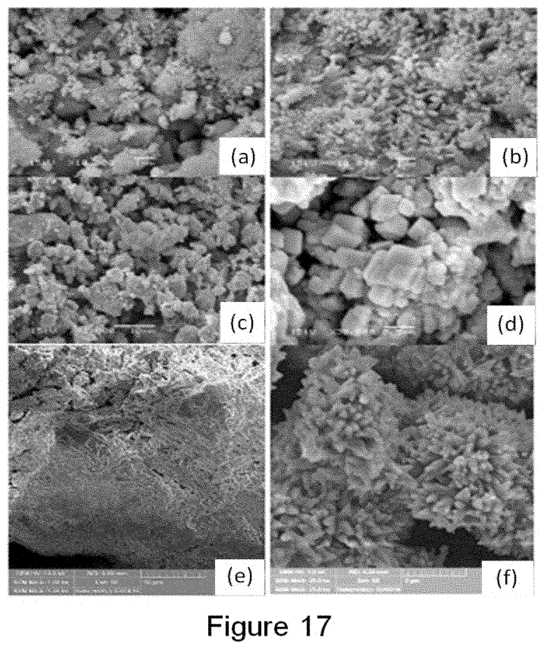

After the allotted reaction period, the reactor was opened and the carbonated solid was removed for its weight determination and further physical analyses using the following instruments: (a) Inductively Coupled Plasma-Atomic Emission (ICP) Spectrometry (ICP-AES) simultaneous to determine the alkali metals and heavy metals, (b) Thermal gravimetric analysis (Perkin Elmer TGA7) to determine sample weight changes as a function of temperature at a heating rate of 20° C./min, (c) Philips x-ray diffractometer model PW/1840 to determine the mineral composition of treated samples, and (d) Scanning Electron Microscope (SEM) with Energy Dispersive X-ray (EDX) to inspect the topographies and chemical composition of the stabilized wastes. FIG. 17 indicates the polymorphs of the formed calcium carbonate particles which depends on the chemical structure of the waste materials and the precipitation conditions.

Water extraction process was used to remove easily soluble salts from the tested solid wastes. Water and solid wastes, at liquid to solid ratio (L/S) of 10 l/kg, were mixed for 15 min and the solid residues were separated by filtration over a 0.45 μm membrane filter. The pH and total dissolved solids (TDS) of the filtrate were analyzed by ICP for selected elements. It is to be noted that for alkaline solid wastes, residues with a native pH value of greater than 10 typically contain portlandite (Ca(OH)₂), which controls the solubility of calcium ions and the pH of solution. The differences in the physical and chemical properties of waste solutions before and after carbonation process are shown in Table 8, which indicates reduction in pH and TDS due to consumption of soluble metal oxides and formation of insoluble carbonates. During precipitation, the pH, conductivity and TDS values gradually decreased due to the growth of calcium carbonate.

TABLE 8
Chemical Analysis of Solid Wastes before and after the stabilization,
Using pH and TDS Instrument Measurements

| | pH | | TDS (ppm) | |
|---|---|---|---|---|
| Type of Wastes | before | after | before | after |
| Ladle Furnace (LF) slag | 11.80 | 10.10 | 644 | 108 |
| Cement kiln dust (CKD) | 12.48 | 08.86 | 13150 | 7460 |
| Carbide lime waste (CLW) | 12.27 | 11.08 | 8240 | 5370 |

The leached concentrations of the metals and heavy metals from carbonated solid waste materials is tested using the leaching test. Metal ion leaching before and after carbonation of solid waste is carried out in accordance with British Standard BS EN12457: 2002, which is designed to examine the short-term and the long-term leaching behavior for landfills. Tables 9a to 9c show the level of contaminants in the three tested wastes before and after carbonation. The results indicated the reduced toxicity of the solid wastes due to the stabilization form of the toxic metals in the carbonated form.

TABLE 9a
Contaminant Levels Before and After Carbonation of CKD
Waste Tested at Constant Temperature of 22° C.

| | Leached (mg/l) | Treatment | % |
|---|---|---|---|
| Constituent | Untreated CKD | CKD | Reduction |
| SO₄ | 1736.5 | 112.4 | 93 |
| Cl | 1286.8 | 673.9 | 47.6 |
| Sr | 11.8 | 0.3 | 97.5 |
| Cr | 17 | 11 | 35.3 |

TABLE 9b
Contaminant Levels Before and After Carbonation
of LF Slag Tested at Constant Temperature of 22° C.

| | Leached (mg/l) | Treatment | % |
|---|---|---|---|
| Constituent | Untreated LF | LF | Reduction |
| SO₄ | (ND) | (ND) | — |
| Cl | (ND) | (ND) | — |
| Sr | 0.6 | 0.05 | 91.7 |
| Cr | 0.9 | 0.23 | 74.4 |

TABLE 9c
Contaminant Levels Before and After Carbonation
of CL Waste Tested at Constant Temperature of 22° C.

| | Leached (mg/l) | Treatment | % |
|---|---|---|---|
| Constituent | Untreated LF | LF | Reduction |
| SO₄ | 1090 | 348 | 68.1 |
| Cl | ND | ND | — |
| Sr | ND | ND | — |
| Cr | ND | ND | — |

The total amount of captured (consumed) CO₂ by solid waste materials are calculated by applying two different methods through using different analyzing devices; gas analyzer 21 and thermogravimetric analysis (TGA). In the first method, CO₂ captured is calculated by employing the gas analyzer 21 readings, which generate a plot of instantaneous consumed CO₂ concentrations. Therefore, the integration (the area under the curve) along the time represents the numerical value of the total consumed amount as described in previous paragraphs of the present disclosure. It is to be noted that a conversion factor is used for each experiment to convert the CO₂ concentration unit from [% v/v] into [g/min] by multiplying the readings by the constant flow rate [l/min] and the density of CO₂.

In the second calculation method, data from thermogravimetric analysis (TGA) were used. Depending on thermal analysis TGA, three major weight fractions obtained are 25-105° C. for the moisture, 105-500° C. for organic elemental carbon and 500-1000° C. for inorganic carbon (carbonates). The weight fraction of the TGA curve (Δm_{500-1000° C.}) based on dry weight (m_{105° C.}) is represented as the calcium carbonate content, expressed in terms of CO₂ (wt. %), as shown by Eq. [2]:

$${CO}_{2} wt ( \% ) = \frac{Δ {m}_{500 - 1000 ° C .}}{{m}_{105 ° C .}} \times 100 \qquad [ 2 ]$$

Given that the amount of CO₂ stored in the waste in the form of carbonates has come from the carbonation process during the specific time. TGA analysis of samples after carbonation gives the total amount of carbonates present in the sample at both its original state (i.e., in fresh sample, before carbonation) and that resulted from chemical reactions with CO₂ gas. So, the actual carbonated amount is the result of subtracting the percentage of that already existed from the total as shown in Table 10.

TABLE 10
Carbonate Percentage of Tested Waste Materials
Using Thermogravimetric Analysis (TGA)

| | Carbonate | | |
|---|---|---|---|
| | percentage | | Actual |
| | (%) | | Carbonated |
| Waste | Fresh | Carbonated | Amount |
| Type | (before) | (after) | (%) |
| LF | 0.3 | 6.8 | 6.5 |
| CKD | 9 | 22 | 13 |
| CLW | 21 | 36 | 15 |

Table 11 displays a comparison between the calculated CO₂ captured using gas analyzer 21 and thermogravimetric analysis (TGA). There is understandable difference between the two methods of calculations due to: (a) the sample size used for TGA analysis does not represent the total population of particles reacted with CO₂ within the reactor; hence the calculated CO₂ consumed (reacted) will be less than the actual amounts, and (b) the experimentally determined CO₂ consumed using gas analyzer 21 does represent the actual reacting media within the reactor as function of time, and accounts for both chemo-sorption, for materials converted onto carbonate and then stored within the waste itself, and physical sorption, for CO₂ absorbed onto the surfaces of non-reacting solid particles. Therefore, the apparent conclusion of such comparison is that the phenomenological method, i.e., the first method of calculation using gas analyzer, provides highly reliable indication of the amount of CO₂ captured without the need to analyze the reacted materials using the thermo-mineralogical testing method (TGA) to calculate the captured CO₂ during carbon sequestration and stabilization of solid alkaline waste processes.

TABLE 11
Comparison Between the Calculated CO₂ Captured Using Gas
Analyzer (GA) and Thermogravimetric Analysis (TGA)
for Samples Tested at Constant Temperature of 22° C., and
Constant Pressure of 1 atm

| | CO₂ captured using | CO₂ | |
|---|---|---|---|
| | GA data | captured | |
| | (g) | using | |
| Waste | (Phenomenological | TGA data | |
| Type | Method) | (g) | (TGA/GA) *100(%) |
| LF | 15.9 | 14.3 | 14.3/15.9 = 89.9 |
| CKD | 33.7 | 28.6 | 28.6/33.7 = 84.9 |
| CL | 37.4 | 33.0 | 33.0/37.4 = 88.2 |

Carbonation (sequestration) efficiency is calculated using Eq. [3], which expressed as:

$${CO}_{2} sequestration efficiency ( \% ) = \frac{ \begin{matrix}Maximum {CO}_{2} \\ Sequestration Capacity\end{matrix}}{ \begin{matrix}Theortical {CO}_{2} \\ sequestration efficiency\end{matrix} } \times 100 \qquad [ 3 ]$$

where, the maximum CO₂ sequestration capacity is calculated using Eq. [2] or the as the calculated total CO₂ consumed by alkaline solid waste during the carbonation process determined experimentally by the gas analyzer, and the theoretical total carbon content based on basic metal oxides present in the fresh samples is calculated using Eq. [4].

% CO₂=0.785(% CaO−0.56% CaCO₃−0.7% SO₃)+1.091% MgO+0.71% Na₂O+0.468% K₂O [4]

Then, the carbonation degree, ξCa (%), can be determined from the carbonate content measured based on: (a) TGA analysis or the phenomenological method using gas analyzer and experimentally monitored data, (b) the molar weights of Ca (Mw Ca), (c) the molar weights of CO₂ (Mw CO₂), and (d) the total theoretical Ca content of the fresh solid waste (Ca total), determined from ICP analysis, as expressed by Eq. [5]:

$$ξ Ca ( \% ) = \frac{\frac{{CO}_{2} ( wt \% )}{1 \; 00 - {CO}_{2} ( wt \% )} \times \frac{{MW}_{Ca} ( kg \text{/} mol )}{M {W}_{{CO}_{2}} ( kg \text{/} mol )}}{{Ca}_{total} ( kg \text{/} kg )} \times 100 \qquad [ 5 ]$$

Using the above described method, the calculated carbonation effectiveness in terms of carbonation efficiency (%), carbonation degree (%), and maximum carbon sequestration (kg CO₂/kg waste) are shown in Table 12a,b. Carbonation effectiveness using TGA Table 12a and that using GA Table 12b are calculated using: (a) both methods for determination of maximum CO₂ sequestration capacity, (b) results obtained from (a) and Eq. [4] for the theoretical maximum CO₂ sequestration capacity, to calculated sequestration efficiency expressed by Eq. [3], and (c) results obtained from (a) and data from ICP analysis discussed previously, and Eq. [5] to calculate carbonation degree. These calculations are detailed below:

The calculated maximum sequestrations (kg CO₂/kg waste) using: (a) GA data are 0.753, 0.708 and 0.294 for CKD, CLW and LF slag, respectively, and (b) TGA data are 0.720, 0.685 and 0.266, respectively.

The calculated carbonation efficiency (%) using: (a) GA data are 91.8, 57.1 and 24.9 for CKD, CLW, and LF slag, respectively, and (b) TGA data are 88.2, 55.5 and 22.7, respectively.

The calculated degree of carbonation (%) using TGA data are 97.6, 72.8 and 22.9, respectively.

These results emphasize the effectiveness of the prescribed system for carbon sequestration and stabilization of active alkaline solid wastes, and the suitability of the phenomenological method to calculate carbonation efficiency and maximum carbon sequestration.

TABLE 12a
Carbonation Effectiveness using TGA

| | Carbonation | Carbonation | Maximum |
|---|---|---|---|
| Solid | efficiency | degree | sequestration |
| residues | (%) | (%) | kg CO₂/kg waste |
| LF slag | 22.7 | 22.9 | 0.266 |
| CKD | 88.2 | 97.6 | 0.720 |
| CLW | 55.5 | 72.8 | 0.685 |

TABLE 12b
Carbonation Effectiveness using GA

| | Carbonation | Maximum |
|---|---|---|
| Solid | efficiency | sequestration |
| residues | (%) | kg CO₂/kg waste |
| LF slag | 24.9 | 0.294 |
| CKD | 91.8 | 0.753 |
| CLW | 57.1 | 0.708 |

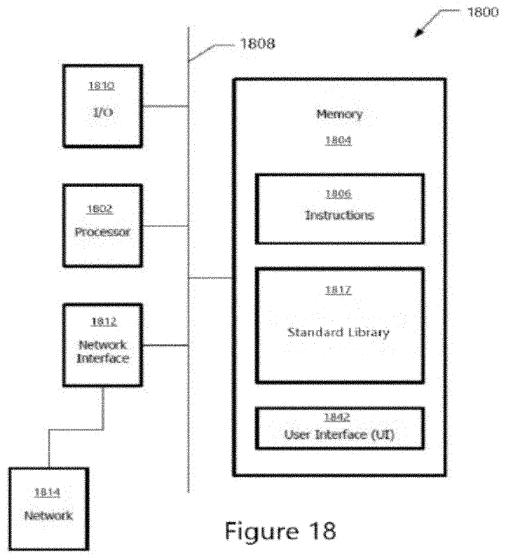

FIG. 18 is a block diagram of a centralized supervisory system 1800, e.g., the centralized supervisory system of FIG. 1, in accordance with some embodiments.

In some embodiments, a centralized supervisory system 1800 is a general-purpose computing device including a hardware processor 1802 and a non-transitory, computer-readable storage medium 1804. Storage medium 1804, amongst other things, is encoded with, i.e., stores, computer program code 1806, i.e., a set of executable instructions. Execution of instructions 1806 by hardware processor 1802 represents (at least in part) a centralized supervisory system tool which implements a portion, or all of the methods described herein in accordance with one or more embodiments (hereinafter, the noted processes and/or methods).

Processor 1802 is electrically coupled to computer-readable storage medium 1804 via a bus 1808. Processor 1802 is also electrically coupled to an I/O interface 1810 by bus 1808. A network interface 1812 is also electrically connected to processor 1802 via bus 1808. Network interface 1812 is connected to a network 1814, so that processor 1802 and computer-readable storage medium 1804 are capable of connecting to external elements via network 1814. Processor 1802 is configured to execute computer program code 1806 encoded in computer-readable storage medium 1804 in order to cause system 1800 to be usable for performing a portion or all of the noted processes and/or methods. In one or more embodiments, processor 1802 is a central processing unit (CPU), a multi-processor, a distributed processing system, an application specific integrated circuit (ASIC), and/or a suitable processing unit.

In one or more embodiments, computer-readable storage medium 1804 is an electronic, magnetic, optical, electromagnetic, infrared, and/or a semiconductor system (or apparatus or device). For example, computer-readable storage medium 1804 includes a semiconductor or solid-state memory, a magnetic tape, a removable computer diskette, a random-access memory (RAM), a read-only memory (ROM), a rigid magnetic disk, and/or an optical disk. In one or more embodiments using optical disks, computer-readable storage medium 1804 includes a compact disk-read only memory (CD-ROM), a compact disk-read/write (CD-R/W), and/or a digital video disc (DVD).

In one or more embodiments, storage medium 1804 stores computer program code 1806 configured to cause system 1800 to be usable for performing a portion or all of the noted processes and/or methods. In one or more embodiments, storage medium 1804 also stores information which facilitates performing a portion or all of the noted processes and/or methods. In one or more embodiments, storage medium 1804 stores a library 1817 including one or more parameters and/or values.

A centralized supervisory system 1800 includes I/O interface 1810. I/O interface 1810 is coupled to external circuitry. In one or more embodiments, I/O interface 1810 includes a keyboard, keypad, mouse, trackball, trackpad, touchscreen, and/or cursor direction keys for communicating information and commands to processor 1802.

A centralized supervisory system 1800 also includes network interface 1812 coupled to processor 1802. Network interface 1812 allows system 1800 to communicate with network 1814, to which one or more other computer systems are connected. Network interface 1812 includes wireless network interfaces such as BLUETOOTH, WIFI, WIMAX, GPRS, or WCDMA; or wired network interfaces such as ETHERNET, USB, or IEEE-1364. In one or more embodiments, a portion or all of noted processes and/or methods, is implemented in two or more systems 1800.

System 1800 is configured to receive information through I/O interface 1810. The information received through I/O interface 1810 includes one or more of instructions, data, design rules, libraries of standard cells, and/or other parameters for processing by processor 1802. The information is transferred to processor 1802 via bus 1808. A centralized supervisory system 1800 is configured to receive information related to a UI through I/O interface 1810. The information is stored in computer-readable medium 1804 as user interface (UI) 1842.

In some embodiments, a portion or all of the noted processes and/or methods is implemented as a standalone software application for execution by a processor. In some embodiments, a portion or all of the noted processes and/or methods is implemented as a software application that is a part of an additional software application. In some embodiments, a portion or all of the noted processes and/or methods is implemented as a plug-in to a software application.

In some embodiments, the processes are realized as functions of a program stored in a non-transitory computer readable recording medium. Examples of a non-transitory computer readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An integrated system for carbon capture and sequestration, and stabilization of alkaline solid wastes, comprising:
a gas feed source containing a reaction gas having a predetermined initial concentration of carbon dioxide (CO₂), wherein the gas feed source comprises at least one mass control valve;
a reaction chamber comprising:
a reactor column having a top open end for receiving a reaction solid and a bottom open end communicating with a gas entrance, wherein the gas entrance is connected with the gas feed source to receive the reaction gas;
a lid covering the top open end of the reactor column;
at least one gas distributor plate connecting the bottom open end of the reactor column with the gas entrance, wherein each of the at least one gas distributor plate includes:
at least two disks having symmetrical holes to provide uniform distribution of the reaction gas through the reactor column; and
at least one mesh, having a mesh size smaller than a particle size of the reaction solid, in between the at least two disks; and
at least one electrical heating element providing an insulated heating source to the reactor column; and
a control panel comprising:
at least one power switch controlling a power supply;
at least one reaction gas flowrate controller controlling the at least one mass control valve through electrical signals to initiate a flow of the reaction gas and define a flow rate of the reaction gas; and
at least one temperature controller controlling the at least one electrical heating element to define a reaction temperature for the reactor column.

2. The integrated system for carbon capture and sequestration, and stabilization of alkaline solid wastes according to claim 1, wherein the reactor column further comprises an expansion portion connected to the top open end of the reactor column, wherein the expansion portion has a larger diameter than a diameter of the reactor column, and wherein the lid instead covers a top opening of the expansion portion.

3. The integrated system for carbon capture and sequestration, and stabilization of alkaline solid wastes according to claim 1, wherein the reaction chamber further comprises at least one thermocouple thermometer configured to detect a temperature at a top section, a middle section, or a bottom section of the reactor column.

4. The integrated system for carbon capture and sequestration, and stabilization of alkaline solid wastes according to claim 3, wherein the control panel further comprises at least one temperature indicator displaying the temperature detected by the at least one thermocouple thermometer.

5. The integrated system for carbon capture and sequestration, and stabilization of alkaline solid wastes according to claim 1, wherein the reaction chamber further comprises a differential pressure transmitter configured to measure a pressure difference across the top open end and the bottom open end of the reactor column.

6. The integrated system for carbon capture and sequestration, and stabilization of alkaline solid wastes according to claim 5, wherein the control panel further comprises a differential pressure indicator displaying the pressure difference measured by the differential pressure transmitter.

7. The integrated system for carbon capture and sequestration, and stabilization of alkaline solid wastes according to claim 1, wherein the gas feed source further comprises a manual valve configured to control a flow rate of the reaction gas.

8. The integrated system for carbon capture and sequestration, and stabilization of alkaline solid wastes according to claim 2, further comprising a reaction analyzing module connected with the expansion portion of the reaction chamber to receive an outlet gas from the reaction chamber, wherein the reaction analyzing module includes:
a cyclone separator configured to separate the outlet gas from solid particles carried out of the reaction chamber by the outlet gas;
a pressure gauge configured to measure an outlet gas pressure;
a gas analyzer configured to measure an outlet concentration of carbon dioxide (CO₂) in the outlet gas; and
a pressure valve connecting the cyclone separator with the gas analyzer, wherein the pressure valve is configured to control pressure inside the reactor column, and to control an outlet flow rate of the outlet gas.

9. The integrated system for carbon capture and sequestration, and stabilization of alkaline solid wastes according to claim 8, wherein the control panel further comprises a pressure indicator displaying the outlet gas pressure measured by the pressure gauge.

10. The integrated system for carbon capture and sequestration, and stabilization of alkaline solid wastes according to claim 9, wherein the integrated system is further connected to a computer having data acquisition and analysis software configured to automatically take the measurements of the outlet concentration of carbon dioxide (CO₂) by the gas analyzer and analyze the measurements of the outlet concentration of carbon dioxide (CO₂) over time.

11. The integrated system for carbon capture and sequestration, and stabilization of alkaline solid wastes according to claim 10, wherein the computer further includes software for a supervisory control and data acquisition (SCADA) system configured to
automatically control the power supply, the at least one mass control valve, the pressure valve, and the electrical heating element; and
automatically take and analyze the measurement of the pressure gauge and the gas analyzer.

12. The integrated system for carbon capture and sequestration, and stabilization of alkaline solid wastes according to claim 11, wherein the reaction analyzer chamber further comprises a safety valve controlled by the supervisory control and data acquisition (SCADA) system to release the outlet gas into the atmosphere based on a determination that the measurement of the outlet gas pressure exceeds beyond a predetermined maximum pressure value.

13. The integrated system for carbon capture and sequestration, and stabilization of alkaline solid wastes according to claim 11, wherein the reaction analyzer chamber further comprises a bypass tube connecting the pressure valve with the bottom open end of the reactor column to reintroduce the outlet gas back into the reactor column, wherein the bypass tube comprises of a flow meter measuring a second outlet flow rate of the outlet gas entering said bypass tube, and wherein the flow meter is controlled by the supervisory control and data acquisition (SCADA) system.

14. An integrated system for carbon capture and sequestration, and stabilization of alkaline solid wastes, comprising:
a gas feed source containing a reaction gas having a predetermined initial concentration of carbon dioxide (CO₂), wherein the gas feed source comprises at least one mass control valve;
a reaction chamber comprising:
a reactor column having a top open end for receiving a reaction solid, an expansion portion connected to the top open end of the reactor column, and a bottom open end communicating with a gas entrance, wherein the gas entrance is connected with the gas feed source to receive the reaction gas, and wherein the expansion portion has a diameter larger than a diameter of the reactor column;
a lid covering a top opening of the expansion portion;
at least one gas distributor plate connecting the bottom open end of the reactor column with the gas entrance, wherein each of the at least one gas distributor plate includes:
at least two disks having symmetrical holes to provide uniform distribution of the reaction gas through the reactor column; and
at least one mesh, having a mesh size smaller than a particle size of the reaction solid, in between the at least two disks;
at least one electrical heating element providing insulated heating source to the reactor column;
at least one thermocouple thermometer configured to detect a temperature at a top section, a middle section, or a bottom section of the reactor column; and
a differential pressure transmitter configured to measure a pressure difference across the top open end and the bottom open end of the reactor column;
a reaction analyzing module connected with the top open end of the reaction chamber to receive an outlet gas from the reaction chamber, wherein the reaction analyzing module includes:
a cyclone separator configured to separate the outlet gas from solid particles carried out of the reaction chamber by the outlet gas;
a pressure gauge configured to measure an outlet gas pressure;
a safety valve to release the outlet gas into the atmosphere based on a determination that the measurement of the outlet gas pressure exceeds a predetermined maximum pressure value,
a gas analyzer configured to measure an outlet concentration of carbon dioxide (CO₂) in the outlet gas; and
a pressure valve connecting the cyclone separator with the gas analyzer, wherein the pressure valve is configured to control a pressure inside the reactor column, and to control an outlet flow rate of the outlet gas;
a bypass tube connecting the pressure valve with the bottom open end of the reactor column to reintroduce the outlet gas back into the reactor column, wherein the bypass tube comprises of a flow meter measuring a second outlet flowrate of the outlet gas entering said bypass tube; and
a control panel comprising:
at least one power switch controlling a power supply;
at least one reaction gas flow rate controller controlling the at least one mass control valve through electrical signals to initiate a flow of the reaction gas and define a flowrate of the reaction gas;
at least one temperature controller controlling the at least one electrical heating element to define a reaction temperature for the reactor column;
at least one temperature indicator displaying the temperature detected by the at least one thermocouple thermometer;
a differential pressure indicator displaying the pressure difference measured by the differential pressure transmitter; and
a pressure indicator displaying the outlet gas pressure measured by the pressure gauge.

15. The integrated system for carbon capture and sequestration, and stabilization of alkaline solid wastes according to claim 14, wherein the integrated system is further connected to a computer having data acquisition and analysis software configured to automatically take the measurements of the outlet concentration of carbon dioxide (CO₂) by the gas analyzer and analyze the measurements of the outlet concentration of carbon dioxide (CO₂) over time.

16. The integrated system for carbon capture and sequestration, and stabilization of alkaline solid wastes according to claim 15, wherein the computer further includes software for a supervisory control and data acquisition (SCADA) system configured to:
automatically control the power supply, the at least one mass control valve, the electrical heating element, the safety valve, the pressure valve, and the flow meter; and
automatically take and analyze the measurements of the at least one thermocouple thermometer, the differential pressure transmitter, the pressure gauge, and the gas analyzer.

17. A method for conducting a carbonation reaction of solid mineral waste particles automatically under determined reaction parameters, the method comprises:
a step determining a reaction flow rate for carbonation, wherein a supervisory control and data acquisition (SCADA) system:
controls a reaction flowrate controller to automatically adjust flow rates of a flowing stream of reaction gas having a predetermined initial concentration of carbon dioxide (CO₂);
automatically acquires differential pressure values, measured by a differential pressure transmitter, between a top open end and a bottom open end of a reactor column, in which the pretreated solid waste particles is mixed with the flowing stream of reaction gas; and
analyzes the differential pressure values as a first function of flow rates of the flowing stream of reaction gas and determines the reaction flowrate base on the first function;
a step determining a reaction time for carbonation, wherein the supervisory control and data acquisition (SCADA) system:
automatically acquires outlet concentrations of carbon dioxide (CO₂) measured by a gas analyzer from an outlet flowing stream of reaction gas expelled from the reactor column;
automatically calculates consumed concentrations of carbon dioxide (CO₂) from the acquired outlet concentration and the initial concentration of carbon dioxide (CO₂); and
analyzes the consumed concentrations of carbon dioxide as a second function of time, generates a first slope of the second function, a second slope of the second function, and determines the reaction time based on the intersection of the first slope and second slope;
a step performing the carbonation reaction wherein the supervisory control and data acquisition (SCADA) system controls the reaction flowrate controller to define a flow rate of the flowing stream of reaction gas corresponding to the determined reaction flowrate; and
a step automatically calculating total amount of carbon dioxide CO₂ consumed during the carbonation reaction, wherein the supervisory control and data acquisition (SCADA) system automatically calculates an integration of the second function from 0 time to a time corresponding to the determined reaction time.

18. The method for method for conducting a carbonation reaction of solid mineral waste particles automatically under determined reaction parameters according to claim 17, wherein the supervisory control and data acquisition (SCADA) system controls a pressure valve to automatically maintain a reaction pressure in the reactor column between 1-10 bars.

19. The method for method for conducting a carbonation reaction of solid mineral waste particles automatically under determined reaction parameters according to claim 17, wherein the supervisory control and data acquisition (SCADA) system controls an electrical heating element to automatically maintains a reaction temperature in the reactor column between 20-200° C.

20. The method for method for conducting a carbonation reaction of solid mineral waste particles automatically under determined reaction parameters according to claim 17, wherein the step determining an optimum carbonation time is performed before the step determining an optimum flow rate.

21. The method for method for conducting a carbonation reaction of solid mineral waste particles automatically under determined reaction parameters according to claim 17, wherein the step determining an optimum flow rate is performed before the step determining an optimum carbonation time.

22. The method for method for conducting a carbonation reaction of solid mineral waste particles automatically under determined reaction parameters according to claim 17, wherein the reaction flow rate is a flow rate corresponding to a maximum value of the differential pressure values on the first function.

23. The method for method for conducting a carbonation reaction of solid mineral waste particles automatically under determined reaction parameters according to claim 17, wherein the first slope of the second function is a tangent line of the second function at a point where a curvature of the second function changes.

24. The method for method for conducting a carbonation reaction of solid mineral waste particles automatically under determined reaction parameters according to claim 17, wherein the second slope of the second functions is a tangent line of the second function at a point where no significant change of the consumed concentrations of carbon dioxide (CO₂) occurs.

25. The method for method for conducting a carbonation reaction of solid mineral waste particles automatically under determined reaction parameters according to claim 17, wherein the pretreated solid waste particles have a particle size of 38 μm-2 mm, and a moisture percentage of 0-4%.

26. The method for method for conducting a carbonation reaction of solid mineral waste particles automatically under determined reaction parameters according to claim 17, wherein the reaction flowrate is between 0.1-50 liter/min.
